(19) United States
(12) Patent Application Publication
(10) Pub. No.: US 2010/0095571 A1
(43) Pub. Date: Apr. 22, 2010

(54) GARMENT WITH INTERCHANGEABLE INDICIA USED TO COUNT

(76) Inventor: Michael Bruce James, New York, NY (US)

Correspondence Address: Michael James, 170 W. 25th St. Apt. 2A, New York, NY, 10001, US

(21) Appl. No.: 12/253,928

(22) Filed: Oct. 17, 2008

(51) Int. Cl. G09F 21/02; A41D 27/08; A44B 18/00

(52) U.S. Cl. 40/586; 2/244; 24/442

(57) ABSTRACT

One embodiment of a garment item which allows wearers to count down or up to any occasion. The embodiment consists of a patch (13), frame (12) and separators (19) on the garment. In conjunction with our incomplete sentence slogans and the combination of numerical appliqués created from base (14) and hook (16), a wearer can look forward to almost any occasion and communicate his or her message to the world.

### BACKGROUND

1. Field

This patent relates to an article of apparel, specifically to a process that allows the wearer to add or remove indicia in order to count down or count up to any occasion.

2. Prior Art

Originally, any article of apparel is intended to serve two primary purposes: function and fashion. The first function of apparel is to clothe and to protect the body from the elements. Another function is fashion. Here, apparel embodies style and may follow current or past trends, with an eye towards making one appear more attractive or desirable. Recently, apparel has come to serve a third purpose: making a statement.

One example is the graphic T-shirt. Today, many graphic tees boast a statement, usually screen-printed. Some examples include: “Vote or Die,” “Everybody Loves An Italian girl,” “Trust Me I'm a Doctor,” and more. In effect, graphic tees communicate messages.

In our current digital age, interactivity is a key component to selling products. Many consumers seek products they can modify or customize. The element of interactivity extends to apparel, however, for many manufacturers this addition can be costly and time-consuming.

There have been some developments in apparel which allow wearers to change the indicia on their garments. An example might be seen on a police officer's uniform where one can interchange indicia through the use of badges backed by Velcro hook applied to the Velcro loop sewn onto the garment. This allows an officer to interchange indicia between uniforms with a specific badge. The benefit of this is that a police department saves money by providing customizable uniforms. In this example, officers can share, reuse and recycle these uniforms.

A disadvantage of this embodiment is that it allows only the communication of a single message: the specific officer's name. Also, the wearer does not have a choice in what type of badge is applied to the garment's loop.

U.S. Pat. No. 4,354,282 of Joel A. Langdon details a garment which includes a front panel having distinctively colored areas thereon with associated indicia indicating the score values of successive scores of a predetermined sports game. The shirt is divided into segments—the top part, indicated by one color, belongs to one team and the bottom part, indicated by another color, belongs to the opposing team. Each team has a lot of 20 colored loop areas with numerical figures (ranging from 1-20) that indicate the score. There are 40 colored loop areas total. There are several disadvantages here:
a. This embodiment only uses the traditional Velcro hook and loop.
b. Applying the 40 colored loop areas that reference numerals for the scores is not only time consuming, but tedious as well, for precise placement is difficult.
c. This embodiment also limits how far one can keep track of the score. Each colored region per team, is allotted 20 points. Many popular sports, such as basketball and football, have scores that go beyond 20.
d. This embodiment lacks a function that specifies which teams are playing, and makes it difficult to discern which color corresponds to which team.
e. The 40 loop areas that are open faced and left unused during the use of this embodiment, may irritate the wearer's skin.

U.S. Pat. No. 4,354,282 focuses on the function that the shirt serves—to permit wearers to keep track of scores during a sports game. It makes no reference as to how the colored loop areas attach to the shirt.

U.S. Pat. No. 5,086,516 of LaVarr Baxter and Roy Baxter describes a coat or jacket that can be worn with detachable declarations of allegiance to a person, group or cause. Instead of buying new jackets for every sports team that one may support, he or she may interchange the pictorial presentations, insignias, logos, etc. These pictorial presentations, insignias, logos, etc. have Velcro strips around the edges on the back. These strips line up, or mate, with a congruent frame of Velcro loop on the jacket. There are several disadvantages to this embodiment:
a. The Velcro strips that frame the pictorial presentation, insignia, logo, etc. does not provide as much support as backing the entire insignia with Velcro.
b. The Velcro loop dulls with time and use.
c. The consumer would have to purchase numerous pictorial presentations, insignia, logos, etc. in order to support a person, group or cause of his or her choosing. This can be extremely costly for the consumer.
d. The pictorial presentations, insignia, and logos heavily depend upon proper licensing from organizations, sports teams, etc. for the use of their logos. This limits options for manufacturers and consumers.
e. Velcro loop material may irritate skin when there is no pictorial presentation, insignia, logo, etc. attached.

### SUMMARY

The embodiment described in this patent application is an apparel item that allows the wearer to count down or up to any occasion directly on the apparel item by interchanging Velcro-like numbers, letters, and figures and applying them on a material that supports Velcro hook. The material, Veltex, is preferred, however, any material that supports Velcro hook can be applied to the shirt as a base for the Velcro-like numbers, letters and figures to be placed.

While we have found that Veltex is the easiest to use as it is flexible and soft, other materials can be used. The Veltex, or any other Velcro hook-supporting material, is not glued or sewn onto the garment like prior art, but it is embroidered directly onto the garment item with a fabric backing, or stabilizer, to prevent the embroidery from ripping or tearing. This method of application ensures that Veltex, or other Velcro hook-supporting material, is secure on the garment and does not irritate the body. We have found that gluing or regular stitching leaves room for the Veltex, or other loop materials, to fray, move, distort, or damage. Our process of embroidering around the Veltex is not only visually appealing, but also ensures that the likelihood of damage to the garment is minimal.

Unlike prior art, our embodiment of garment items with interchangeable indicia does not rely on the use of pictures, logos, or other pictorial insignia but rather numbers, letters and symbols. It is the combination of said interchangeable numbers along with incomplete sentence slogans that allow the wearer to communicate the countdown or count up to an occasion. While no prior art discovered in our search relies upon this combination of interchangeable numbers and incomplete sentences to communicate a message, the absence of said slogans from our embodiment do not prohibit the wearer from utilizing the garment to count.

### DRAWINGS—FIGURES

In the drawings, closely related figures have the same number but different alphabetic suffixes.

FIG. 1 shows a front view of a t-shirt with the embroidered counting frame.

FIG. 2A is a close up of the counting frame.

FIG. 2B is a close up of the counting frame with a Velcro appliqué, which in this case is a number.

FIG. 3 shows a side view of a t-shirt and the counting frame.

FIG. 4 shows a side view of the t-shirt and the components of the counting frame.

FIGS. 5A to 5C show the Velcro appliqué from aerial front, angled and aerial back views.

FIG. 6 shows the t-shirt with the counting frame and the Velcro number appliqués on the counting frame.

### DRAWINGS—REFERENCE NUMERALS

10 t-shirt garment

11 frontal view of t-shirt

12 frame

13 Veltex, or other Velcro hook supporting fabric, patch

14 appliqué base

15 applique embroidery

16 Velcro hook backing

17 Stabilizer

18 Slogan

19 Separator

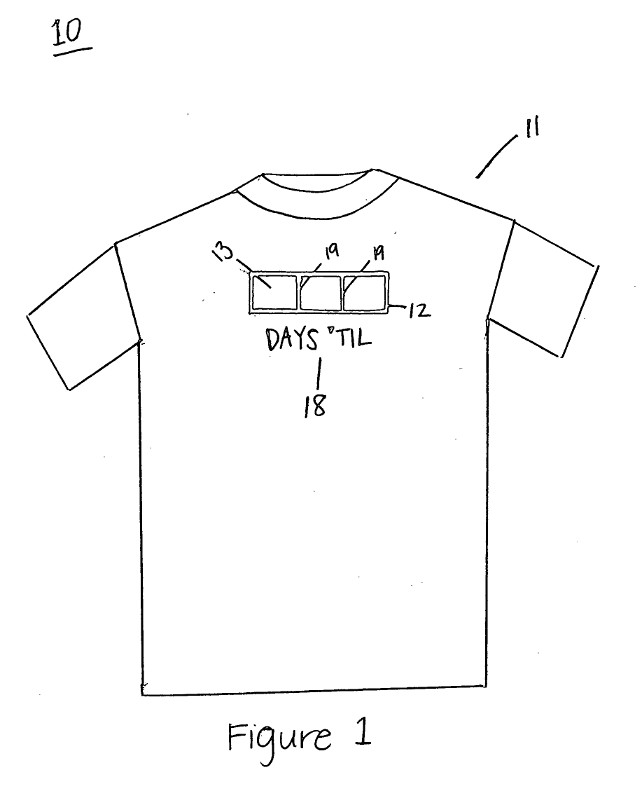

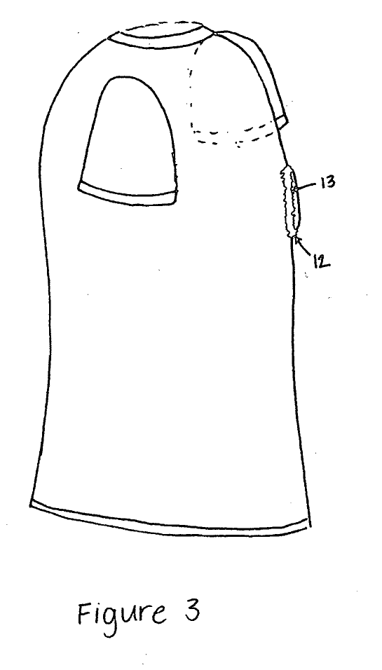

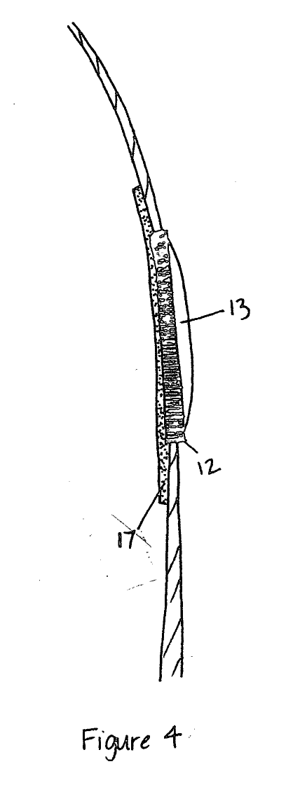

### DETAILED DESCRIPTION—FIGS. 1, 2A, 2B, 3, 4, 5A, 5B, 5C

Referring to FIG. 1, (10) indicates a t-shirt garment. The garment can be substituted with a variety of other garment items: long-sleeve shirts, jackets, coats, pants, sweat pants, shorts, underwear, swimwear, and more. A piece of Velcro hook-supporting and compatible material, or Veltex, is cut to a desired shape. We prefer to use a rectangular shape but any shape can be used, including, but not limited to, circles, triangles, hearts, etc. The Veltex is then embroidered around the shape, creating a frame (12) of stitching. Embroidery, or repetitive stitching, is preferred but any other form of stitching or adhesive can be use to secure the Veltex, or hook-supporting material, onto the garment. Again, we prefer to use this material called Veltex, but any flexible or soft material that mates with Velcro hook can be used.

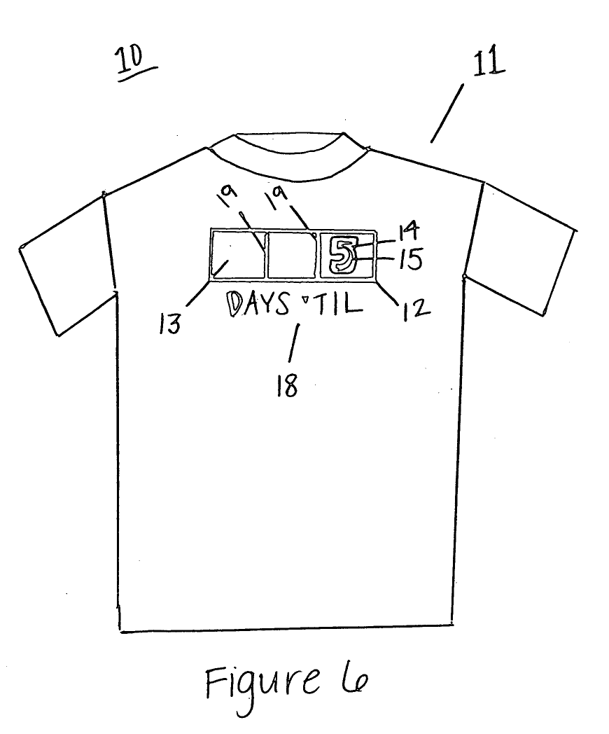

Embodiment frame (12) in FIGS. 1, 2, 3, 4, 6 is represented by a rectangular shape, but can be any shape ranging from circles, triangles, squares, and more as mentioned previously. The embodiment can range in variety of shape and size. We prefer that the embodiment be proportional to the surface space of the garment.

Typically, the frame that surrounds the Veltex is two inches tall and six inches long, but this varies depending upon the shape that is used to create the embodiment. When creating the frame (12) around the Veltex, the embroidery does not have to go through the Veltex patch (13). We prefer to use extra embroidered lines, Separators (19), through the Veltex patch (13), in order to create a stylistic look similar to that of an odometer. However, not all embodiments need to have Separators (19) through patch (13). This is merely our preference.

When attaching the patch to the garment with the embroidered frame, an extra material is used to enhance the grip of the stitching. This stabilizer (17) can be of any thin, soft material such as felt, paper, cotton, and more. Stabilizer (17) acts as a backing and provides additional support while a needle secures the embroidery. Stabilizer (17) can ultimately be removed by either the manufacturer or the wearer, but our embodiment prefers to include it in order to ensure that the embroidery, or any other form of stitching, does not tear, rip, or irritate the wearer.

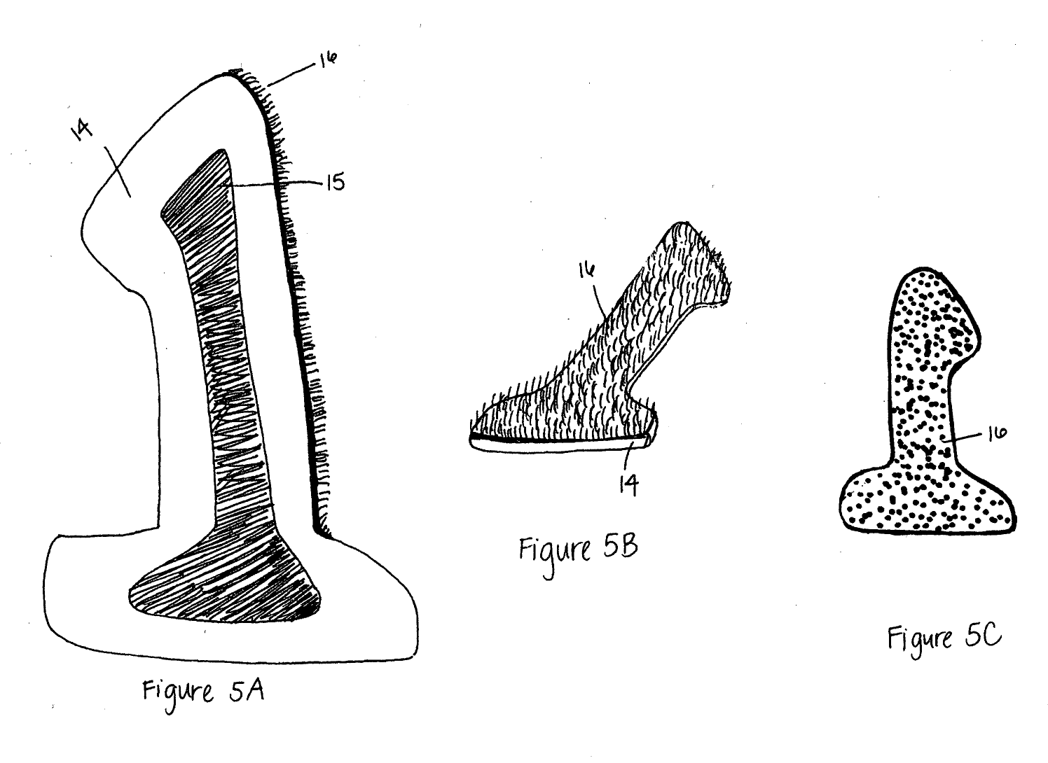

FIGS. 5A, 5B, 5C show a complementary embodiment to the garment with patch (13) and frame (12). This insignia, or appliqué, can also be of any shape. We prefer appliques in the shape of numerals, which permits wearers to manually perform this embodiment's function, which is to count down or up to an occasion.

Appliques are typically 1.5 inches tall and 1.25 inches wide, but can vary depending on the size and style of the patch on garments. Insignia is cut into desired figures, we prefer numbers, with scissors, dye-cut or laser-cut from felt or other soft material to create the appliqué base. This appliqué base can be embellished with embroidery, stitching, printing, jewels, and more. FIG. 5A shows an appliqué that is embellished with embroidery (14). Then, Velcro hook congruent to the shape and size of the appliqué base is applied, through glue, stitching or means, to the appliqué base. This creates our preferred insignia, however, any early steps in creating the appliqués can be altered. For example, instead of using our preferred felt, appliqués can be directly cut from Velcro hook. This also creates appliqués which can be used to perform the function of our embodiment. As seen in FIG. 5B, any appliqué is functional when the underside has Velcro hook.

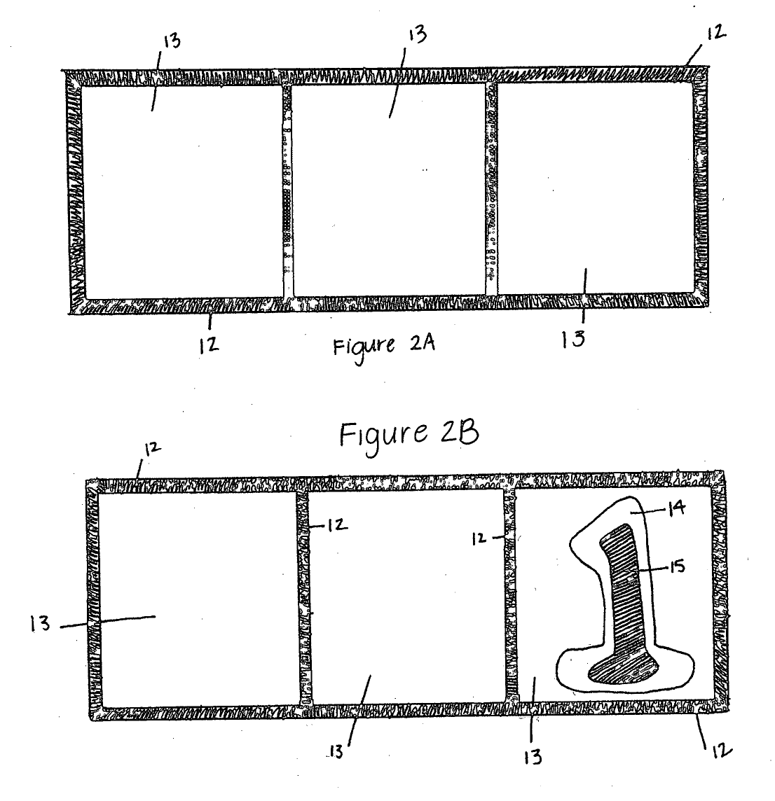

### Operation—FIGS. 2B, 4, 5A, 5B, 5C, 6

By using the number appliqués demonstrated in FIGS. 5A, 5B 5C, wearers can apply or remove number appliqués onto the Veltex patch (13) that is secured to the garment by the frame (12). We prefer to include with the garment 23 (twenty-three) Velcro number appliqués, ranging from number 0-9, however, the quantity of appliqués can vary. Per each set of 23 appliques, the following quantities of numbers are included:
“0”—2
“1”—3
“2”—3
“3”—2
“4”—2
“5”—2
“6”—2
“7”—2
“8”—2

TOTAL: 23

Each garment has a slogan, of incomplete sentence structure, beneath the patch, referencing an occasion or event the wearer is looking forward to or anticipating: The occasion can be birthdays, holidays, anniversaries, Election Days, and much, much more. We anticipate that our list of slogans will grow. Through the combination of a slogans, in conjunction with the addition or subtraction of these numerical appliqués, users can count down—or up-to any occasion, and display the message for others to see. The three-digit combination of these 23 number appliqués, in conjunction with our incomplete sentence slogans, is designed to allow the wearer to count down—or up—365 days—encompassing an entire calendar year.

As stated previously, although we prefer to pair our embodiment with the use of incomplete slogans for maximum effect, it is important to note the absence of slogans from our embodiment does not prohibit the wearer from utilizing the garment to count.

### Advantages

Almost everyone looks forward to or anticipates the arrival of an occasion, event or happening. We prefer to think of this action as a countdown. With our embodiment, not only can the wearer remind himself or herself of the days remaining until said occasion, event or happening, but he or she can share the excitement with others.

Combined with our fun, inspirational and mass market slogans, our process of adding and removing the numerical appliqués is not only enjoyable, but more comfortable than prior art, because it avoids the use of Velcro directly applied to the garment itself. The patch (13) is typically a softer material while stabilizer (17) adds an extra layer of protection from irritation to the skin.

Our method of counting down or up using removable insignia is also convenient because the process is non-mechanical, non-digital and non-electric, requiring only the energy of the wearer to calculate the days until their desired date.

### Conclusion, Ramifications and Scope

Accordingly, the reader will see that by adding and removing the indicia from the garment the wearer can count down or up to an occasion, event or happening. Furthermore, the garment with interchangeable indicia has the additional advantages:
(a) It is a fun and interactive method of counting on apparel.
(b) The materials being used, specifically Veltex on the garment, is a safer, more comfortable and attractive alternative than using Velcro hook on the garment.
(c) Our embodiment, which allows wearers to count up or down to written, implied, unwritten or decided upon occasions, events or happenings, is a non-mechanical, non-electric and non-digital process, requiring only the manual action of the wearer to operate.

Although the description above contains many specificities, these should not be construed as limiting the scope of the embodiments, but as merely providing illustrations of some of the presently preferred embodiments. For example, the counting frame used to display the removable indicia can be of any material capable of mating with Velcro hook; the counting frame can have other shapes; the removable indicia can have a different backing, provided the counting frame mates with that backing, etc. Thus, the scope of the embodiments should be determined by the appended claims and their legal equivalents rather than by the examples given.

I claim:

1. A means for counting and identifying the number of days to an occasion, event or happening on a garment item with removable indicia and sentence structures, comprising:

2. A portion of material supports Velcro hook, similar to Veltex, cut into a desired shaped and applied to said garment of claim 1,

3. Said portion of Velcro hook supporting material of claim 2 applied to garment of claim 2 by any method.

4. The body of said removable indicia of claim 1 is in the shape of a number, letter or symbol with backing of a material similar to Velcro hook.

5. Indicia of claim 1 can alternatively be arranged to have Velcro loop if the portion of material of claim 2 performs a similar function of Velcro hook.

6. The sentence structures of claim 1 communicate no message alone.
